(19) United States
(12) Patent Application Publication
(10) Pub. No.: US 2011/0192251 A1
(43) Pub. Date: Aug. 11, 2011

(54) SELF ADJUSTING DEVICE FOR CABLE-OPERATED CONTROLS

(76) Inventor: Raymond Harold LOCKETT, JR., Carson City, NV (US)

(21) Appl. No.: 13/022,009

(22) Filed: Feb. 7, 2011

Related U.S. Application Data
(60) Provisional application No. 61/302,225, filed on Feb. 8, 2010.

(51) Int. Cl. G05G 1/04

(52) U.S. Cl. 74/511 R; 74/504

(57) ABSTRACT

A self-adjusting device for cable operated controls, such as, but not limited to, clutch control mechanisms for motorcycles, has a cable that can be adjusted automatically when a lever, such as a clutch control lever, is operated to disengage or engage the clutch. This can be done mechanically without using hydraulic master and slave cylinders. The self-adjusting device causes the cable to be adjusted automatically by the normal action of operation of a lever and cable system without the necessity of a separate action by the operator to cause the cable to remain in proper adjustment in all circumstances and under extreme operating conditions that would otherwise cause the cable to loosen or tighten. For a clutch mechanism, this self-adjusting action allows engine power to fully transfer to the vehicle drive wheel and improves vehicle performance as well as extends the useful life of the vehicle clutch system.

### CROSS-REFERENCE TO RELATED APPLICATIONS

This application claims the benefit of priority of U.S. Provisional patent application Ser. No. 61/302,225, filed Feb. 8, 2010, which is herein incorporated by reference.

### BACKGROUND OF THE INVENTION

The present invention relates to self-adjusting cable assemblies and, more particularly, to a self-adjusting device for cable-operated controls, such as, but not limited to, a clutch control lever for a motorcycle.

Conventional clutch mechanisms may require careful maintenance by a user to maintain proper adjustment, especially under extreme operating conditions that may otherwise cause the vehicle clutch to loosen or tighten. Some conventional systems may include complex hydraulics to maintain proper adjustment.

As can be seen, there is a need for a simple and efficient clutch mechanism design to maintain proper clutch adjustment.

### SUMMARY OF THE INVENTION

In one aspect of the present invention, a self-adjusting cable actuation device comprises a shuttle block having a first engagement surface, the shuttle block adapted to receive a cable; a housing enclosing the shuttle block, the housing adapted to allow lateral movement of the shuttle block when the actuation device is in a neutral position; a lock pawl having a second engagement surface, the lock pawl pivotally disposed in the housing; a lever extending from the housing, the lever pivoting about a lever pivot pin, the lever pivot pin within the housing, wherein when the actuation device is in an engaged position, an end portion of the lever engages the lock pawl, causing the lock pawl to pivot and further causing the first and second engagement portions to engage.

In another aspect of the present invention, a self-adjusting clutch mechanism for a motorcycle comprises a clutch lever pivotally attached to a lever pivot pin; a lock pawl having a compression spring and pivotally attached to a pawl pivot pin, the clutch lever disposed to be in communication with the lock pawl, such that when the clutch lever pivots in one direction the lock pawl pivots in an opposite direction from the clutch lever; a shuttle block disposed to retain a clutch cable, the shuttle block and the lock pawl comprising complementary engaging surfaces that are disposed to engage when the clutch lever pivots to engage the shuttle block and the clutch cable in a locked position; a perch mount attached to a motorcycle handle; and a housing disposed to contain the clutch lever, the lock pawl with compression spring, and the shuttle block, the housing pivotally attached to the perch mount by way of a perch mount pivot pin having a torsion spring disposed to apply rotating tension between the housing and perch mount to rotate the housing toward a perch stop.

These and other features, aspects and advantages of the present invention will become better understood with reference to the following drawings, description and claims.

### BRIEF DESCRIPTION OF THE DRAWINGS

FIG. 1 is a partial cross-sectional view of a clutch mechanism in a disengaged condition according to an exemplary embodiment of the present invention;

FIG. 2 is a partial cross-sectional view of the clutch mechanism of FIG. 1 is an engaged position;

FIG. 3 is an exploded view of the clutch mechanism of FIG. 1;

FIG. 4 is a close-up view of the disengaged clutch mechanism of FIG. 1; and

FIG. 5 is a close-up view of the engaged clutch mechanism of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, an embodiment of the present invention provides a self-adjusting device for cable operated controls, such as clutch mechanisms for motorcycles. In the self-adjusting device of the present invention, the cable length can be adjusted automatically when a lever, such as a clutch lever, is operated to disengage or engage the clutch. This can be done mechanically without using hydraulic master and slave cylinders. The self-adjusting device causes the cable to be adjusted automatically by the normal action of operation of a lever and cable system without the necessity of a separate action by the operator to cause the cable to remain in proper adjustment in all circumstances and under extreme operating conditions that would otherwise cause the cable to loosen or tighten. For a clutch mechanism, this self-adjusting action allows engine power to fully transfer to the vehicle drive wheel and improves vehicle performance as well as extends the useful life of the vehicle clutch system.

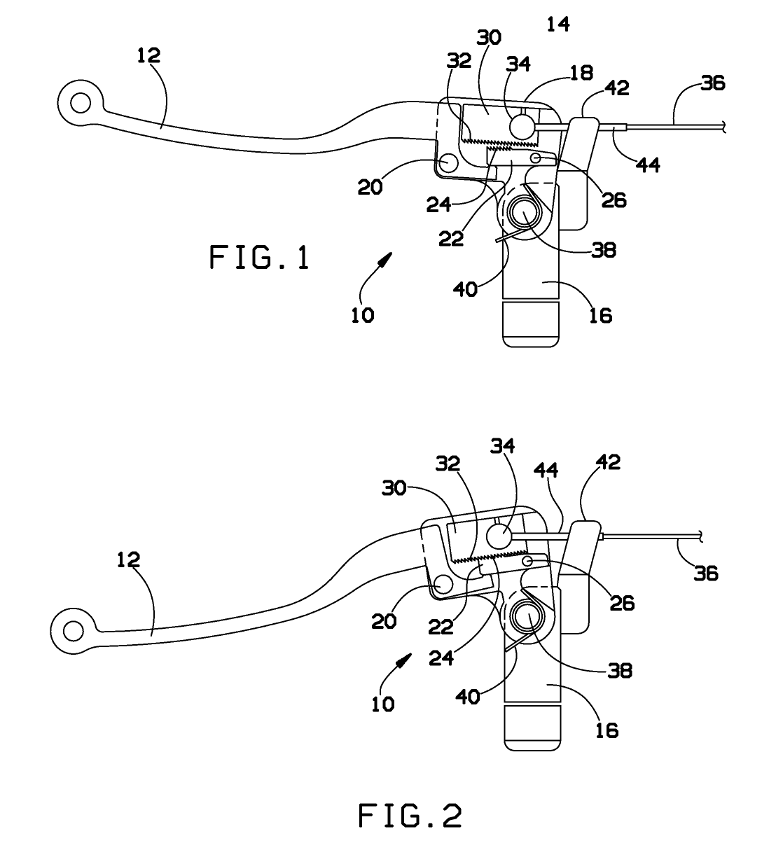

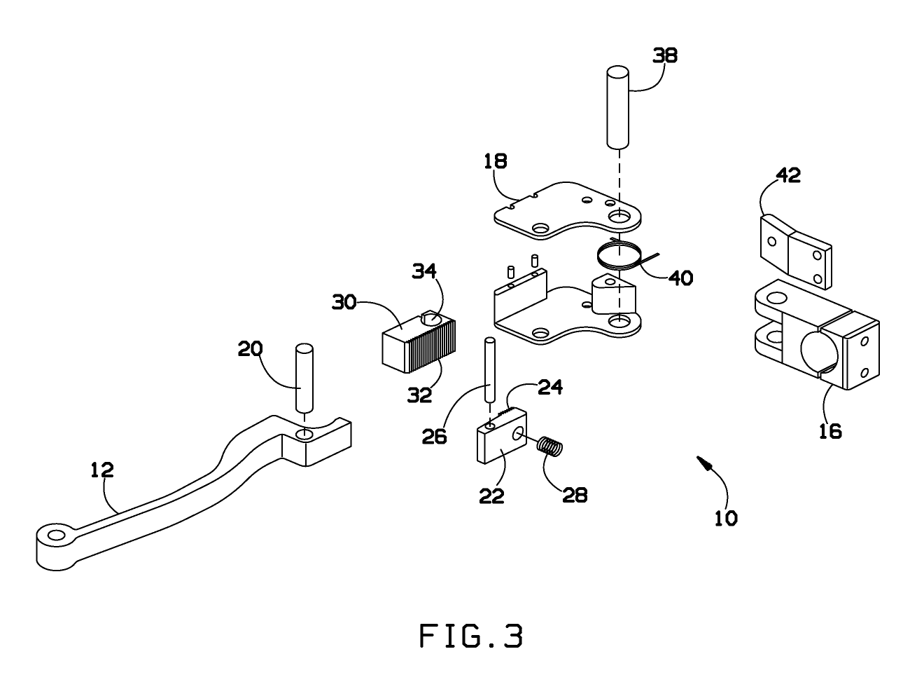

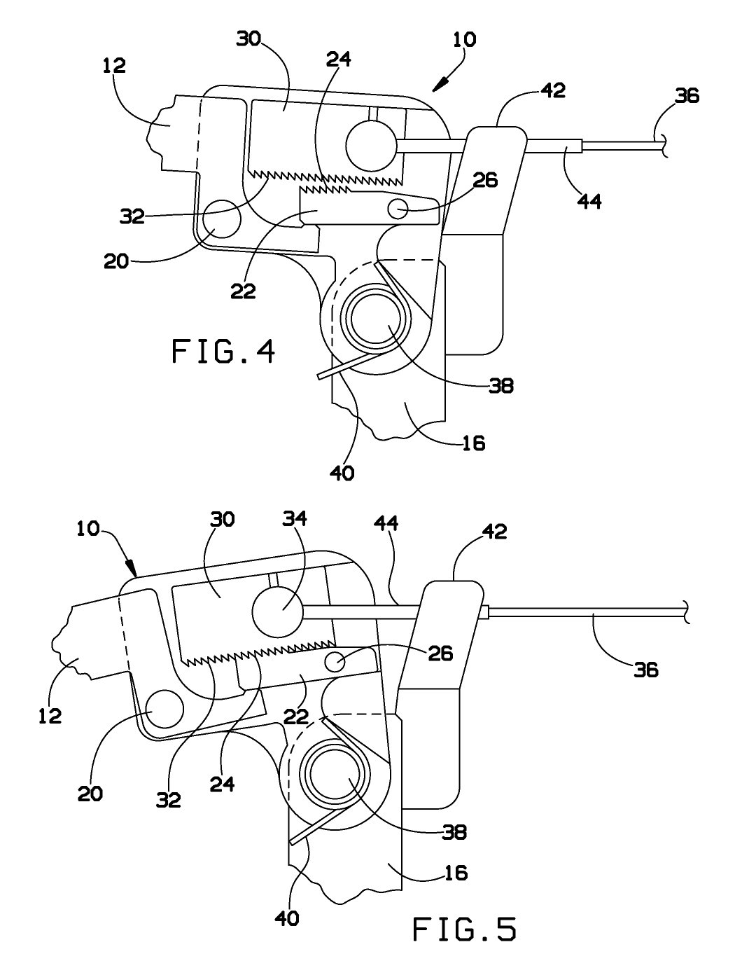

Referring to FIGS. 1 through 5, a clutch mechanism 10 may include a clutch lever 12, a self-adjusting mechanism 14 operationally connected to the clutch lever 12 and a perch mount 16 adapted to mount the clutch mechanism 10 to a motorcycle (not shown). The clutch lever 12 may be comprised of, for example, cast or machined aluminum or plastic composite material. The clutch lever 12 may be between about 4″ to about 6″ in length, and may be between about ½″ and about ¾″ thick. The clutch lever 12 may be attached to an inside of a housing 18. The clutch lever 12 may pivot about a pin 20, for example, a steel dowel pin, to cause a lock pawl 22 to move in the opposite direction of the clutch lever 12 travel.

The lock pawl 22 may be comprised of, for example, alloy steel or stainless steel that can be machined or cast. The lock pawl 22 may include a complementary engagement surface, such as teeth 24 machined or ground at between about a 30 to 45 degree angle and between about 0.020″ to 0.050″ deep on a top portion. The teeth 24 can be between about 0.020″ to 0.050 from the center of each of the adjacent teeth. The lock pawl 22 may pivot about a pawl pivot pin 26. A compression spring 28 may be located on a bottom portion of the lock pawl 22, for example about ⅛″ from a right edge, that may cause the lock pawl 22 to pivot in the direction that moves it away from teeth 32 on a shuttle block 30 when in neutral position, and moves the lock pawl 22 toward the shuttle block 30 causing the teeth 24, 30 to engage and thus lock the shuttle block 30 in fixed position when the clutch lever 12 is pulled.

The shuttle block 30 may be made from a similar material as the lock pawl 22 and may be machined or cast. The shuttle block 30 may have a complementary engagement surface, such as teeth 32 machined or ground at between about a 30 to 45 degree angle and between about 0.025″ to 0.040″ deep on an entire bottom portion, and matching the number and pitch of the teeth 24 on the lock pawl 22. The shuttle block 30 may include a hole 34 drilled through a side to allow a vehicle clutch cable 36 to be inserted and retained in shuttle block 30. The shuttle block 30 may travel freely, without restriction, in a linear motion in the housing 18 to compensate for changes in cable length. The shuttle block 30 may slide freely when the lever 12 is in a neutral position (see FIG. 1), allowing the cable 36 to find a position and be locked into a fixed position when the lever 12 is moved slightly away from a home position, causing the lock pawl 22 to engage the shuttle block 30 and lock the position of the shuttle block 30 and the connected clutch cable 36 (see FIG. 2).

The housing 18 may be comprised of machined or cast aluminum top and bottom plates and contain the lever 12, the lock pawl 22 with the compression spring 28, and the shuttle block 30.

The perch mount 16 can be comprised of machined or cast aluminum and may be attached to a vehicle handle bar (not shown), for example by means of two bolts between about 4 mm and 6 mm in diameter, and may allow the lever 12 and housing 18 to pivot about a perch mount pivot pin 38. A torsion spring 40 may be located around the perch mount pivot pin 38. The torsion spring 40 may apply minimal, but constant rotating tension between the housing 18 and the perch mount 16, causing the housing 18 and all of its internal components to be rotated toward a perch stop 42 while the lever 12 is in the released, neutral position. The perch stop 42 can be a machined or cast aluminum part that may be attached to the perch mount 16, for example, by way of two about 4 mm to 6 mm bolts, and may restrict the travel of the housing rotation about the perch mount pivot pin 38. An outer housing 44 for the clutch cable 36 may be retained in the perch stop 42, allowing the clutch cable 36 to move without restriction within the outer housing.

The clutch lever 12 can pivot about the lever pivot pin 20 and cause energy to transfer to lock pawl 22. The lock pawl 22 can pivot about a separate pawl pivot pin 26 and transfer energy to the shuttle block 30 and lock the shuttle block 30 in a fixed position. The lock pawl 22 may be spring loaded to cause motion away from shuttle block 30 when in a disengaged position. The shuttle block 30 may be connected to the clutch cable 36 and may travel laterally in the housing 18 to compensate for changes in cable length. The shuttle block 30 can be attached to the clutch cable 36 and can be allowed unrestricted lateral movement when the lock pawl 22 is disengages. The shuttle block 30 and the clutch cable 36 may be in a locked position within housing 18 when lock pawl 22 is engaged by the downward movement of the lever 12 by an operator. The housing 18 may be spring loaded to pivot back to neutral position when disengaged.

The vehicle operator can pull the clutch lever 12 to disengage the clutch, whereby the lever 12 can pivot on its axis and contact the spring loaded lock pawl 22, causing the lock pawl 22 to pivot on its axis and travel toward the shuttle block 30. Upon contact with the shuttle block 30, the teeth 24 of the lock pawl 22 can engage the teeth 32 on the shuttle block 30 and lock the shuttle block 30 in position. As the lever pulling motion is continued, the housing 18, with all internal components can rotate on the perch mount pivot pin 38, causing the cable to pull and disengage the vehicle clutch. When the lever 12 is released, the housing 18 can pivot back to the starting position and the stop pawl 22 can disengage from the shuttle block 30 and the clutch cable 36 may be released to allow movement to a neutral position in the housing 18.

In alternative embodiments, the position lock pawl 22 may be changed in relation to the lever 12 and shuttle block 30. The lock pawl 22 can be pushed from the top portion and the lever pivot position can be moved to the same position as the housing pivot position.

While the above Figures describe a motorcycle clutch assembly, the present invention may be applicable for any cable actuated mechanism, such as, for example, a bicycle brake engagement mechanism.

It should be understood, of course, that the foregoing relates to exemplary embodiments of the invention and that modifications may be made without departing from the spirit and scope of the invention as set forth in the following claims.

What is claimed is:

1. A self-adjusting cable actuation device, comprising:
a shuttle block having a first engagement surface, the shuttle block adapted to receive a cable;
a housing enclosing the shuttle block, the housing adapted to allow lateral movement of the shuttle block when the actuation device is in a neutral position;
a lock pawl having a second engagement surface, the lock pawl pivotally disposed in the housing;
a lever extending from the housing, the lever pivoting about a lever pivot pin, the lever pivot pin within the housing, wherein
when the actuation device is in an engaged position, an end portion of the lever engages the lock pawl, causing the lock pawl to pivot and further causing the first and second engagement portions to engage.

2. The actuation device of claim 1, further comprising a compression spring, the compression spring adapted to separate the first and second engagement portions when the actuation device is in the neutral position.

3. The actuation device of claim 1, further comprising a perch mount adapted to connect the housing of the actuation device to a motorcycle.

4. The actuation device of claim 3, further comprising a perch mount pivot pin adapted to allow the housing to pivot relative to the perch mount.

5. The actuation device of claim 3, further comprising a torsion spring adapted to apply constant rotating tension between the housing and the perch mount, causing the housing and all of its internal components to be rotated toward a perch stop while the lever is in the released position.

6. The actuation device of claim 1, wherein the lock pawl pivots about a pawl pivot pin disposed inside the housing.

7. The actuation device of claim 1, wherein the shuttle block has a hole cut therein, the hole adapted to contain an end member of the cable.

8. The actuation device of claim 1, wherein the lever is a clutch lever of a motorcycle and the cable is a clutch cable.

9. A self-adjusting clutch mechanism for a motorcycle, comprising:
a clutch lever pivotally attached to a lever pivot pin;
a lock pawl having a compression spring and pivotally attached to a pawl pivot pin, the clutch lever disposed to be in communication with the lock pawl, such that when the clutch lever pivots in one direction the lock pawl pivots in an opposite direction from the clutch lever;
a shuttle block disposed to retain a clutch cable, the shuttle block and the lock pawl comprising complementary engaging surfaces that are disposed to engage when the clutch lever pivots to engage the shuttle block and the clutch cable in a locked position;
a perch mount attached to a motorcycle handle; and
a housing disposed to contain the clutch lever, the lock pawl with compression spring, and the shuttle block, the housing pivotally attached to the perch mount by way of a perch mount pivot pin having a torsion spring disposed to apply rotating tension between the housing and perch mount to rotate the housing toward a perch stop.
